(19) United States
(12) Patent Application Publication
(10) Pub. No.: US 2008/0201429 A1
(43) Pub. Date: Aug. 21, 2008

(54) System Supporting Live Electronic Messaging Communication Between A Healthcare Worker And A Patient

(75) Inventors: Alan S. Barbell, Horsham, PA (US); Venkat Dandibhotla, Collegeville, PA (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Medical Solutions USA, Inc., Malvern, PA (US)

(21) Appl. No.: 12/033,317

(22) Filed: Feb. 19, 2008

Related U.S. Application Data
(60) Provisional application No. 60/890,219, filed on Feb. 16, 2007.

(51) Int. Cl. G06F 15/16; G06Q 50/00

(52) U.S. Cl. 709/205; 705/3

(57) ABSTRACT

A system supports live electronic messaging communication between a healthcare worker and a patient. The system includes a communication processor for establishing a bidirectional, real-time, secure text message communication link between a healthcare worker at a first location and a patient at a location remote from the first location. The communication processor supports bidirectional live text message communication between the worker and the patient. An authorization processor examines received patient and worker identification data to validate patient identity and worker entitlement to access a medical record of the patient. A user interface uses validated patient identification data for providing at least one display image including medical data of the patient derived from the medical record of the patient. The medical data of the patient is viewable concurrently by the healthcare worker and the patient while concurrently engaging in text message communication. A data processor stores a transcript record of a bidirectional live text message communication session between the worker and the patient in the medical record of the patient.

This is a non-provisional application of provisional application Ser. No. 60/890,219 filed Feb. 16, 2007, by V. Dandibhotla et al.

### FIELD OF THE INVENTION

The present invention relates to a system for supporting communications between a patient and a healthcare worker, and in particular to a system for providing enhanced data for both the patient and healthcare worker.

### BACKGROUND OF THE INVENTION

Interactions between healthcare workers and patients when outside a healthcare setting pose significant challenges to the safe and effective delivery of care. When a patient interacts with a healthcare worker in an office/hospital setting, the healthcare worker has access to the patient's medical records, as kept by that healthcare worker. Access to this information enables the healthcare worker to review the patient's medical history and put the patient's current conversation and exam within context to that patient's specific medical and family situation. Further, information from the patient's medical record may be shared with the patient and explained by the healthcare worker. In addition, the healthcare worker may update the patient's medical record in a relatively timely fashion during and/or after the end of the interaction.

However, face to face clinical interactions are not always feasible due to many practical limitations posed by limited healthcare worker capacity, patient ability to travel, ability for insurance to pay for visits, and so forth. In such cases, a patient may desire an interaction with his healthcare worker from a non-office/hospital location. For example, a patient may call his doctor's office seeking medical advice or direction, or a prescription or a refill authorization for an existing prescription. A care manager may call a patient in conjunction with a disease, or chronic care, management program; or the patient may call the care manager with questions about their chronic condition or care plan. Typically a caregiver and a remote patient communicate through regular phone lines in known systems. However, in addition to, or as a substitute for, telephone calling, as just described, a communication between patient and healthcare worker may consist of establishing a text messaging link, such as instant messaging (IM) or other textual interaction, or voice over IP (VOIP) via a wide area network (WAN) such as the Internet.

There is a significant work effort in the traditional process on part of the healthcare workers as they need to document what transpired between them and the patient. This increases the average patient handling time and decreases their ability to respond to other patients needs. Further the patient also needs to transcribe important aspects of the conversation, i.e. the directions provided by the healthcare worker. Some systems that have a connection to a personal health record enable the healthcare worker to push information to the patient healthcare record electronically, but it is information that is either already prepared, such as the answer to a “frequently asked question” or information that is manually typed by the healthcare worker after the call to summarize the conversation for the patient.

Such systems have the following drawbacks. The patient's medical record is not available to be shared with the patient, either in whole or in part. Extra effort is required to transcribe results of the patient healthcare worker interaction. The healthcare worker may miss details of completed conversation(s) when manually transcribing them. No direct documentation exists of information provided by the patient that was used in making clinical decisions. Transcripts of the conversation are not sent to patient's personal health record. Work saturation of care healthcare workers minimizes the time spent by the healthcare worker on documentation after every phone conversation.

A system supporting live electronic messaging communication between a healthcare worker and a patient which addresses these deficiencies and related problems is desirable.

### BRIEF SUMMARY OF THE INVENTION

In accordance with principles of the present invention, a system supports live electronic messaging communication between a healthcare worker and a patient. The system includes a communication processor for establishing a bidirectional, real-time, secure text message communication link between a healthcare worker at a first location and a patient at a location remote from the first location. The communication processor supports bidirectional live text message communication between the worker and the patient. An authorization processor examines received patient and worker identification data to validate patient identity and worker entitlement to access a medical record of the patient. A user interface uses validated patient identification data for providing at least one display image including medical data of the patient derived from the medical record of the patient. The medical data of the patient is viewable concurrently by the healthcare worker and the patient while concurrently engaging in text message communication. A data processor stores a transcript record of a bidirectional live text and/or VIOP message communication session between the worker and the patient in the medical record of the patient.

### BRIEF DESCRIPTION OF THE DRAWING

In the drawing:

FIG. 1 is a block diagram of a system supporting live electronic messaging communication between a healthcare worker and a patient in accordance with principles of the present invention;

FIG. 2 is a more detailed network diagram illustrating the interconnection between a patient location and a healthcare worker location, according to principles of the present invention;

FIG. 3 is a more detailed block diagram of a system illustrated in FIG. 1, according to principles of the present invention; and

FIG. 4 and FIG. 5 are process flow diagrams useful in understanding the operation of the system illustrated in FIG. 1 and FIG. 3 in accordance with principles of the present invention.

### DETAILED DESCRIPTION OF THE INVENTION

A processor, as used herein, operates under the control of an executable application to (a) receive information from an input information device, (b) process the information by manipulating, analyzing, modifying, converting and/or transmitting the information, and/or (c) route the information to an output information device. A processor may use, or comprise the capabilities of, a controller or microprocessor, for example. The processor may operate with a display processor or generator. A display processor or generator is a known element for generating signals representing display images or portions thereof. A processor and a display processor comprises any combination of, hardware, firmware, and/or software.

An executable application, as used herein, comprises code or machine readable instructions for conditioning the processor to implement predetermined functions, such as those of an operating system, a system supporting live electronic messaging communication between a healthcare worker and a patient, or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters.

A user interface (UI), as used herein, comprises one or more display images, generated by the display processor under the control of the processor. The UI also includes an executable procedure or executable application. The executable procedure or executable application conditions the display processor to generate signals representing the UI display images. These signals are supplied to a display device which displays the image for viewing by the user. The executable procedure or executable application further receives signals from user input devices, such as a keyboard, mouse, light pen, touch screen or any other means allowing a user to provide data to the processor. The processor, under control of the executable procedure or executable application manipulates the UI display images in response to the signals received from the input devices. In this way, the user interacts with the display image using the input devices, enabling user interaction with the processor or other device. A graphical user interface (GUI) uses graphical display images, as opposed to textual display images, when generating the UI.

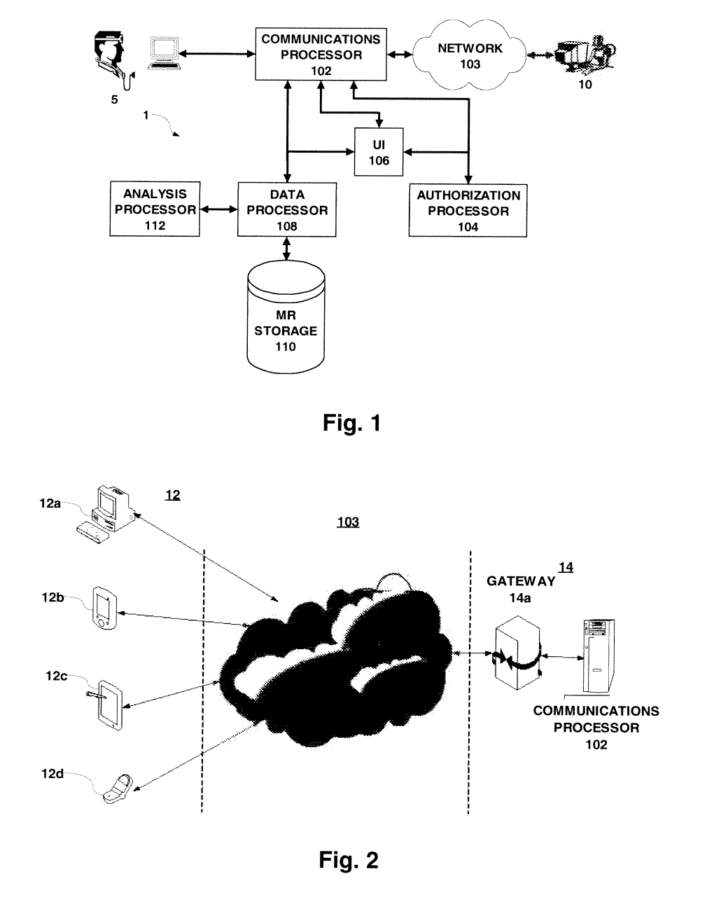

FIG. 1 is a block diagram of a system 1 supporting live electronic messaging communication between a healthcare worker 5 and a patient 10. In FIG. 1, a communication processor 102 establishes a bidirectional real-time secure text message communication link between the healthcare worker 5 at a first location and a patient 10 at a location remote from the first location via a network 103, such as a wide area network (WAN), for example, the Internet. The communications processor 102 may further establish a bidirectional real-time secure voice-over-IP communication link. Either or both communications links may be used concurrently by the healthcare worker 5 and patient 10.

FIG. 2 is a more detailed network diagram illustrating the interconnection between a patient location 12 and a healthcare worker location 14, according to principles of the present invention. In FIG. 2, the patient location 12 includes one or more network interactive devices. For example, a patient 10 (FIG. 1) may have access to one or more of a computer and/or terminal 12a, a personal digital assistant (PDA) 12b, a handheld pen-based computer 12c and/or a cell phone 12d. These devices are coupled to the WAN, e.g. Internet, 103. The WAN 103 is also coupled to devices at a healthcare worker 5 location 14. A gateway 14a provides a means for attaching the local area network at the healthcare worker 5 location 14 to the WAN, e.g. Internet, including address translation and firewall capabilities. The gateway 14a couples the WAN 103 to the communication processor 102.

Referring again to FIG. 1, communication processor 102 supports bidirectional live text message or VOIP voice communication, for example, between the healthcare worker 5 and the patient 10. An authorization processor 104 examines received patient 10 and healthcare worker 5 identification data to validate patient 10 identity and healthcare worker 5 entitlement to access a medical record of the patient 10. When both the identity of the patient 10 and the entitlement of the healthcare worker to access the medical record of that patient 10 are validated, the bidirectional live text message communication link is established, and the healthcare worker 5 and patient 10 may carry on a text message conversation.

A user interface (UI) 106, using validated patient identification data, provides at least one display image including medical data of the patient 10 derived from the medical record of the patient 10. In an embodiment, the user interface 106 provides the at least one display image automatically, using the validated patient identification information, in response to a user initiating establishment of the bidirectional real-time secure text message communication link. In this embodiment, the user may be either the healthcare worker 5 or the patient 10, The UI 106 may provide the at least one display image in the form of a textual display, or the UI 106 may provide the at least one display image in the form of a graphical image by the use of a text-based graphical description language.

The medical data of the patient 10 is advantageously viewable concurrently by the healthcare worker 5 and the patient 10 while concurrently engaging in text message and/or VOIP voice communication. A data processor 108 stores a transcript record of the bidirectional live text message communication session between the healthcare worker 5 and the patient 10 in the medical record of the patient 10. In one embodiment, the data processor 108 automatically stores the transcript record in the medical record of the patient 10. In another embodiment, the data processor 108 stores the transcript record in the medical record of the patient 10 in response to a user command.

The data processor 108 also generates a summary of the transcript record. For example, the healthcare worker 5 may retrieve the transcript record of the bidirectional live text message communication, and, using an editor embodied in the data processor 108, edit that transcript into a form suitable for communication to the patient 10. In another embodiment, the data processor may automatically extract appropriate passages from the transcript record using artificial intelligence (Al) or other similar techniques to form the summary. This summary may be further edited by the healthcare worker 5 as described above. The summary of the transcript record is automatically communicated by the communication processor 102 to the patient 10. The medical record of the patient 10 is stored in a medical record (MR) storage device 110 which may contain medical records of more than one patient.

The healthcare worker 5 and the patient 10 may also initiate a telephone conversation concurrently with the bidirectional live text message communication session. In this case, the data processor 108 further stores a transcript record of the telephone conversation between the worker and the patient in the medical record 110 of the patient 10.

In another embodiment, the system 1 includes an analysis processor 112 for analyzing data provided by the patient 10 via the bidirectional real-time secure text message communication link in conjunction with data in the medical record of the patient 10 to support treatment decision making by the healthcare worker 5. The analysis processor 112 will be described in more detail below.

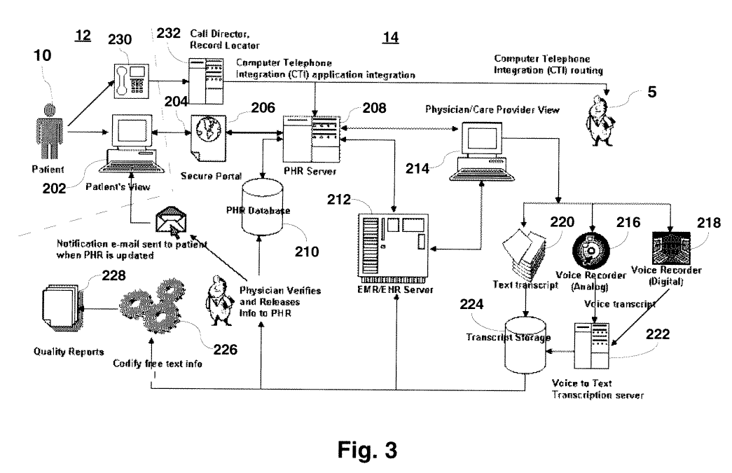

FIG. 3 is a more detailed block diagram of a system illustrated in FIG. 1, according to principles of the present invention. Those elements which are the same as those illustrated in FIG. 1 are designated by the same reference number, and are not described in more detail below. In FIG. 3, a healthcare worker 5 and a patient 10 may establish electronic communication from locations remote from each other. The patient 10, at the patient's location 12 has access to a computer 202 which has access to a WAN 204, such as the Internet. The WAN 204 couples the patient computer 202 to a secure portal 206 at the healthcare worker location 14, such as a doctor's office or hospital or the like.

The secure portal 206 operates as the communications processor 102 (of FIG. 1). That is, the secure portal 206 receives text data from and provides text data to the patient's computer 202. This data may represent a display image in the form of a textual UI, or may provide a graphical UI (GUI) by use of a text-based graphical description language. For example, the secure portal 206 may operate as a world-wide-web server providing text-based hypertext markup language (html) data to the patient's computer 202, which displays a GUI described by that text-based data.

The secure portal 206 also provides the operations of the authorization processor 104 (of FIG. 1). That is, the secure portal 206 verifies the identity of the patient 10 using one or more of: a Smart Card; a bio-metric scanner, such as a fingerprint scanner; a unique log-in procedure; password verification, and/or other method for ensuring secure and accurate determination of the identity of the patient 10 accessing the secure portal 206. Similarly, the authorization processor 104 identifies a healthcare worker 5 and verifies access by the healthcare worker 5 to medical data corresponding to the patient 10 is carried out by enterprise security protocols. For example, such protocols include one or more of: a Smart Card, a bio-metric scanner, security tokens, a healthcare worker 5 unique log-in procedure, password verification, and/or any other measures that are in place in a healthcare enterprise. The ability to access any patient information is governed by role-based security mechanisms that are implemented in the EMR, and PHR applications.

The secure portal 206 is coupled to a personal health record (PHR) server 208. The PHR server 208 is coupled to a database 210 containing the personal health records maintained by the patients associated with the healthcare worker location 14. The PHP 208 is also coupled to a server 212 containing electronic medical records (EMR) maintained by healthcare workers associated with the healthcare facility at location 14 and/or electronic health records (EHR) maintained by healthcare workers associated with other facilities at other locations. The PHR server 208 and the EMR/EHR server 212 are also coupled to the computer or terminal 214 of the healthcare worker 5.

The healthcare worker computer or terminal 214 may also coupled to an analog voice recorder 216, a digital voice recorder 218 and/or a text transcription device 220. The analog voice recorder 216 and digital voice recorder 218 are coupled to a voice-to-text transcription server 222. The text transcription device 220 and voice-to-text transcription server 222 are coupled to a transcript storage device 224. The transcript storage device 224 is coupled to the EMR/EHR server 212 and the PHR server 210. In addition, communication may be initiated between the transcript storage device 224 and the patient computer 202. In the illustrated embodiment, this link is illustrated as an e-mail link. In addition, a further database processor 226 is coupled to the transcript storage device 224, the EMR/EHR server 212 and the PHR server 210. The database processor 226 codifies free, or unstructured text, and may produce quality reports 228.

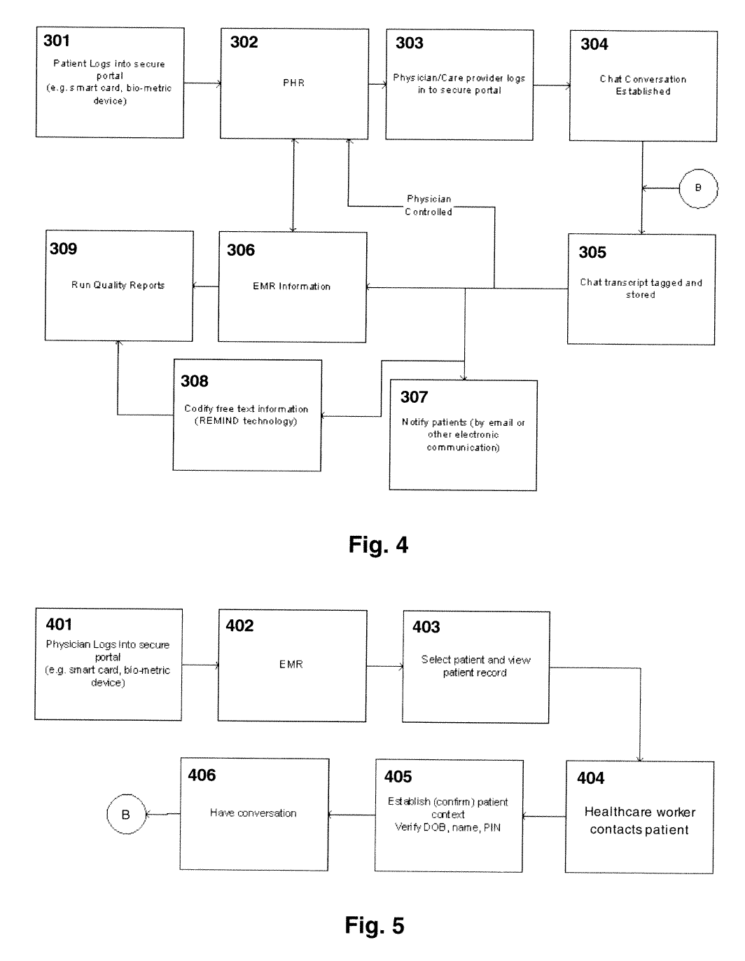

The operation of the system 1 illustrated in FIG. 1 and FIG. 3 may be more easily understood by reference to the flowcharts illustrated in FIG. 4 and FIG. 5. The system 1 functions when the originator of the secure text message communication link (e.g., internet chat) is either the healthcare worker 5 or the patient 10.

FIG. 4 shows the flow of process that occurs when a patient 10 originates the communication to a healthcare worker 5 via an electronic text based communication. In block 301, the patient 10 logs onto a secure portal 206 (FIG. 3) via the WAN 204 (e.g. Internet). As described above, the secure portal 206 provides the function of the authorization processor 104. The patient 10 may authenticate themselves to the system 1 using a variety of technologies, including but not limited to passwords, smart cards, biometric devices, and the like. In block 302, the authorized patient 10 accesses their personal health record in the PHR server 208. This data may be displayed on the display device of the patient's computer 202 in textual form or in graphical form, as described above. The patient 10 may review their medical information, document any self measured data, and/or request initiation of communications with the healthcare worker 5.

One method of communication may be an online electronic text chat. The chat may be established either by an on-demand request from the patient 10, or in response to the occurrence of a prescheduled event. The secure portal 206 (FIG. 3) sends a request to the computer/terminal 214 of the healthcare worker 5 to establish a communication session. To establish the chat, the healthcare worker 5 needs to log on to the communication system in block 303. The secure portal 206 verifies the identity of the healthcare worker 5, and also verifies that the identified healthcare worker 5 is authorized to access the medical records of the previously identified patient 10. If the healthcare worker 5 is entitled to access the medical record of the patient 10, the PHR server 208 provides data to the healthcare worker 5 computer/terminal 214. A chat session is then established in block 304. Once the chat session is established, the patient 10 and healthcare worker 5 can communicate via online text chat. As described above, the medical data of the patient 10 is viewable concurrently by the healthcare worker 5 and the patient 10 while concurrently engaging in the text message communication. It is also possible for the EMR/EHR server 212 to provide additional medical record data of the patient 10 to the computer/terminal 214 of the healthcare worker 5.

A transcript of the text message conversation is maintained by the text transcription device 220 (FIG. 3), and is stored and tagged with specific meta-data for future recovery and use in the transcript storage device 222 in block 305. At the completion of the text message chat, the healthcare worker 5 has the ability to store the transcript in the patient's electronic medical record maintained in the EMR/EHR server 212 in block 306. In one embodiment, the transcript is automatically stored in the patients electronic medical record. In another embodiment, the healthcare worker 5 initiates storing the transcript. The healthcare worker 5 also has the ability to send at least part of the transcript, such as the healthcare worker's 5 final recommendation to the patient's personal health record maintained by the PHR server 208 in the PHR database 210. To ensure that the patient 10 is informed of the update to his PHR containing the chat transcript information, the patient is notified by e-mail, or some other appropriate electronic communication, of the update in block 307. The patient 10 may log in and review the transcript summary. The healthcare worker 5 also may dictate voice notes concerning the communication session using the analog voice recorder 216 and/or digital voice recorder 218. Such voice notes are transcribed by the voice-to-text server 222 and also stored in the transcript storage device 224.

The completed transcript is also processed by the codify-free-text-information database processor 226 (FIG. 3) in block 308. The automatically processed text information may be stored in the EMR/EHR server 212. This information may also be used in the generating of quality reports in block 309. More specifically, the database processor 226 operates as the analysis processor 112 (of FIG. 1). The analysis processor 112 includes data mining tools. The data-mining tools (not shown in detail) may analyze patient data, including text and natural language text, both structured and unstructured (e.g. free text), and further including data from multiple sources using probabilistic analysis algorithms and medical domain knowledge. The data mining tools may be used to extract and combine existing structured and unstructured clinical data to yield relatively high quality structured clinical information. This involves accessing and extracting raw data from multiple data sources (text processing being just one type of extraction) and combining conflicting local evidence to yield a conclusion. The data from the data-mining tools is used in the analysis processor 112, along with the standard evidence based clinical knowledge that is available from different sources. The local evidence, which in this case is the patient's 10 medical data and diagnosis, is compared against the evidence based knowledge to determine the deviation in diagnosis and treatment of the patient from a typical diagnosis and treatment as determined by the data-mining. The system also draws conclusions using inferences based on external medical domain knowledge, such as content management system (CMS) quality Indicators, to combine data from multiple sources and to enforce consistency between different medical conclusions drawn from the data e.g. using probabilistic reasoning. Such information supports treatment decision making by the healthcare worker 5.

Another scenario of this process is when the communication is originated by the healthcare worker 5. FIG. 5 illustrates the process wherein the healthcare worker 5 first logs into a secure portal in block 401. In the same manner as the patient 10 described above, the healthcare worker 5 logs into the electronic medical record system using, e.g. a smart card, biometric device, unique login procedure, password, or the like. This provides information to the authorization processor (FIG. 1) to determine which medical records the healthcare worker 5 is entitled to access. In block 402, the healthcare worker 5 accesses the electronic medical records. In block 403, the healthcare worker 5 selects the patient 10 with whom they wish to communicate from, e.g. a list of authorized patients. The healthcare worker 5 accesses the medical record information from the EMR server 212 (FIG. 3) and it is displayed on the computer/terminal 214 of the healthcare worker 5. This information includes communication information, such as electronic addresses, text message names, and also phone numbers, of the patient 10. The provider can request an electronic text message communication with the patient 10 through the secure portal 206 in block 404.

When a person responds to the communication request, the system 1 needs to confirm and/or validate that that person is the desired patient 10. As before, a smart card, biometric device, unique login procedure, password or the like may be used to verify the identity of the person answering the request. Other verifying information may also be requested from the person answering the request, such as their date of birth, name, personal identification number (PIN) and so forth. When the person answering the communication request has been properly verified as the desired patient 10, then the requested electronic text message communication may be established.

As before, the PHR server 208 (FIG. 3) may provide data representing a GUI containing the patient's 10 personal health record from the PHR server 208 (FIG. 1) to the computer 202 of the patient 10, and concurrently a GUI containing the patient's 10 personal health record and possibly also containing the patient's 10 electronic medical record from the EMR/EHR server 212, to the computer/terminal 214 of the healthcare worker 5. Concurrently, the healthcare worker 5 and the patient 10 have an electronic text message conversation in block 406. The process then follows the same steps, described above following connector B in FIG. 4. That is, a transcript of the conversation is maintained, coded, and stored. The transcript may be added to the patient health record, and a notification may be sent to the patient 10.

It is also possible for a phone conversation to be established in addition to, or in place of, the electronic text message conversation. For example, the patient 10 may use his telephone 230 (FIG. 3) at the patient location 12 to call the healthcare worker 5 location 14. This call is received by a call director 232. The call director 232 extracts caller ID information from the telephone call, if available, and uses that information to locate a patient medical record in the PHR server 208 corresponding to the caller ID information.

The steps described above with respect to access and verification of the identity of a patient 10, and the supplying of a GUI to the patient 10 with patient healthcare record information are performed. In addition, the steps for concurrently providing a GUI of the patient healthcare record information and possibly information related to the electronic medical record for the patient to the healthcare worker 5 are also performed. These steps may be initiated by the patient logging into the secure portal 206 (FIG. 3) or by the healthcare worker 5 initiating a communication link to the patient 10, as described above. However, in this case, one of the patient 10 or healthcare worker 5 initiates a telephone call. In this case, not only is a record of the electronic text message session maintained, but also a sound recording of the telephone conversation, automatically recorded, for example, by the digital voice recorder 218, is maintained and stored at the end of the session.

The system 1 described above, and illustrated in the drawing, advantageously (a) improves safety because it allows the healthcare worker 5 to see medical information related to the patient 10 before initiating any communication with the patient 10; (b) allows the healthcare worker 5 to automatically document the electronic or voice communication and update in the patient's electronic medical record; (c) allows the healthcare worker 5 to send a transcript (possibly edited) of the communication to patient's 10 personal health record; (d) decreases the average patient handling time per healthcare worker 5 because they don't have to document a communication from scratch after they finish the communication; and (e) provides an audit trail of information collected and questions asked in justifying clinical decision.

It is described above that the system of FIG. 3 is at the location of the doctor's office or hospital. However, it is possible that the secure portal 206 and remainder of the elements of FIG. 3, with the exception of the patient's terminal 202 and healthcare worker's terminal 214 is located remote from both the patient's location 12 and the doctor's location 14.

What is claimed is:

1. A system supporting live electronic messaging communication between a healthcare worker and a patient, comprising:
a communication processor for establishing a bidirectional real-time secure text message communication link between a healthcare worker at a first location and a patient at a location remote from said first location and supporting bidirectional live text message communication between said worker and said patient;
an authorization processor for examining received patient and worker identification data to validate patient identity and worker entitlement to access a medical record of said patient;
a user interface, using validated patient identification data, for providing at least one display image including medical data of said patient derived from said medical record of said patient, said medical data of said patient being viewable concurrently by said healthcare worker and said patient while concurrently engaging in text message communication; and
a data processor for storing a transcript record of a bidirectional live text message communication session between said worker and said patient in said medical record of said patient.

2. A system according to claim 1, wherein the communication processor further establishes a bidirectional real-time secure voice-over-IP communication link.

3. A system according to claim 1, wherein:
said healthcare worker and patient may initiate a telephone conversation concurrently with said bidirectional live text message communication session; and
the data processor further stores a transcript record of the telephone conversation between said worker and said patient in said medical record of said patient.

4. A system according to claim 1 wherein said authorization processor verifies said patient identity using one or more of: a Smart Card, a biometric scanner, a unique log-in procedure, and password verification.

5. A system according to claim 1, wherein said authorization processor identifies a healthcare worker and verifies access by said healthcare worker to medical data corresponding to a patient by enterprise security protocols.

6. A system according to claim 7, wherein said enterprise security protocols include one or more of: a Smart Card, a bio-metric scanner, security tokens, healthcare worker unique log-in procedure, password verification.

7. A system according to claim 1, wherein said user interface provides said at least one display image automatically, using validated patient identification information, in response to a user initiating establishment of said bidirectional real-time secure text message communication link.

8. A system according to claim 7, wherein said user is said patient.

9. A system according to claim 7, wherein said user is said healthcare worker.

10. A system according to claim 7, wherein said user interface provides said at least one display image in the form of a textual image.

11. A system according to claim 7, wherein said user interface provides said at least one display image in the form of a graphical image by use of a text-based graphical description language.

12. A system according to claim 11, wherein the text-based graphical description language is text-based hypertext markup language.

13. A system according to claim 1, wherein:
said data processor generates a summary of said transcript record; and
said summary of said transcript record is automatically communicated by said communication processor to said patient.

14. A system according to claim 1, further comprising an analysis processor for analyzing data provided by said patient via said bidirectional real-time secure text message communication link, in conjunction with data in said medical record of said patient, to support treatment decision making by said healthcare worker.

15. A system according to claim 14, wherein said analysis processor comprises data mining tools which analyze patient data, including text and natural language text, structured and unstructured, and further including data from multiple sources, using probabilistic analysis algorithms and medical domain knowledge.

16. A system according to claim 15, wherein said data mining tools extract and combine existing structured and unstructured clinical data to yield relatively high quality structured clinical information.

17. A system according to claim 1, wherein said data processor automatically stores said transcript record in said medical record of said patient.

18. A system according to claim 1, wherein said data processor stores said transcript record in said medical record of said patient in response to user command.

19. A system supporting live electronic messaging communication between a healthcare worker and a patient, comprising:
a communication processor for establishing a bidirectional real-time secure voice-over-IP message communication link between a healthcare worker at a first location and a patient at a location remote from said first location and supporting bidirectional live voice-over-IP message communication between said worker and said patient;
an authorization processor for examining received patient and worker identification data to validate patient identity and worker entitlement to access a medical record of said patient;
a user interface, using validated patient identification data, for providing at least one display image including medical data of said patient derived from said medical record of said patient, said medical data of said patient being viewable concurrently by said healthcare worker and said patient while concurrently engaging in voice-over-IP message communication; and
a data processor for storing a transcript record of a bidirectional live text message communication session between said worker and said patient in said medical record of said patient.

20. A system according to claim 11, wherein said communication processor also establishes a bidirectional real-time secure text message communication link between said healthcare worker at said first location and said patient at said location remote from said first location.
